(19) United States
(12) Patent Application Publication
(10) Pub. No.: US 2008/0257654 A1
(43) Pub. Date: Oct. 23, 2008

(54) Counterweight With Partially Imbedded Buffer

(76) Inventors: John M. Milton-Benoit, West Suffield, CT (US); Bons Traktovenko, Avon, CT (US); Robert Hammell, Killingworth, CT (US)

Correspondence Address: CARLSON GASKEY & OLDS, 400 W MAPLE STE 350, BIRMINGHAM, MI, 48009, US

(21) Appl. No.: 12/089,454

(22) PCT Filed: Oct. 12, 2005
(86) PCT No.: PCT/US05/36654

§ 371 Date: Apr. 7, 2008

(51) Int. Cl. B66B 17/12

(52) U.S. Cl. 187/404

(57) ABSTRACT

An elevator counterweight (24, 34) includes a buffer member (40) supported for movement with the counterweight within a hoistway (26). The buffer member (40) includes a first portion (52) that is within an outer boundary of a structure (42) of the counterweight. A second portion (54) of the buffer member (40) is beyond the outer boundary. In disclosed examples, a plurality of fillers are supported by a frame such that a first filler (60) has a first width dimension and at least one second filler (62) has a smaller width dimension. The second filler (62) can be positioned alongside the first portion (52) of the buffer member (40).

### FIELD OF THE INVENTION

This invention generally relates to elevator systems. More particularly, this invention relates to a counterweight and buffer arrangement for use in an elevator system.

### DESCRIPTION OF THE RELATED ART

Many elevator systems includes a car and counterweight coupled together by a rope or other load bearing member such as a belt. A machine controls movement of the car to service passengers between various levels in a building, for example. As known, the counterweight and car typically move in opposite directions within a hoistway.

It has been proposed to include multiple elevator cars within a single hoistway. Such an arrangement provides advantages for increased or improved passenger service, for example. U.S. Pat. No. 1,896,776 is an example patent pertaining to an elevator system having multiple cars within a hoistway.

There are various challenges presented when trying to provide multiple cars in a hoistway. For example, the increased number of components generates needs for different types of safety devices. U.S. Pat. No. 1,896,776, for example, shows buffers carried by the counterweights and cars for absorbing impact between the counterweights or the cars, respectively. One disadvantage to such an arrangement is that the buffers increase the envelope of the counterweights, the cars or both. Doing so takes up additional hoistway space, which is at a premium. Moreover, the position of buffers as shown in that patent hinders the ability to position the elevator cars at immediately adjacent floors, for example.

There is a need for an arrangement that provides a buffer feature in a cost-efficient and space-efficient manner. This invention addresses that need.

### SUMMARY OF THE INVENTION

An example counterweight for use in an elevator system includes a structure that defines an outer boundary of the counterweight. A buffer member has a first portion within the outer boundary.

In one example, the buffer member has a second portion beyond the outer boundary that is moveable relative to the first portion for absorbing energy associated with contact with another counterweight.

In one example, the structure comprises a frame and the counterweight includes a plurality of fillers supported by the frame. Some of the fillers have a dimension that allows them to fit along side the first portion of the buffer member. This allows for a more compact counterweight design compared to one that relies upon fillers that extend across an entire width dimension of the frame. In one example, such larger fillers are used in combination with the smaller-sized fillers.

The various features and advantages of this invention will become apparent to those skilled in the art from the following detailed description of currently preferred embodiments. The drawings that accompany the detailed description can be briefly described as follows.

### BRIEF DESCRIPTION OF THE DRAWINGS

FIG. 1 schematically illustrates selected portions of an elevator system including a counterweight having a buffer supported for movement with the counterweight.

FIG. 2 schematically shows one example counterweight embodiment.

FIG. 3 shows another example counterweight embodiment.

### DETAILED DESCRIPTION OF THE PREFERRED EMBODIMENTS

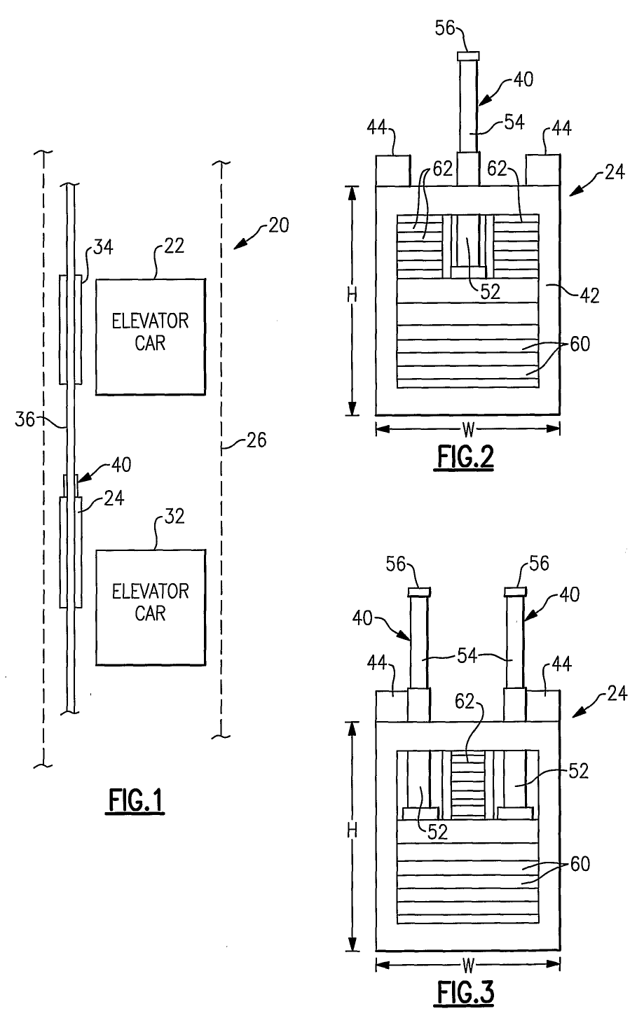

FIG. 1 schematically shows selected portions of an elevator system 20. A first elevator car 22 is coupled with a first counterweight for movement within a hoistway 26. Although not shown in FIG. 1, the first elevator car 22 is coupled to the first counterweight 24 by a plurality of ropes or belts as known. A second elevator car 32 is positioned below (according to the drawing) the first elevator car 22. The second elevator car 32 is associated with a second counterweight 34 by a load bearing member (not shown) so that both move within the hoistway 26 as known.

In this example, the counterweights 24 and 34 travel along common guide rails 36. In other words, the counterweights 24 and 34 share the same guide rails 36.

Another feature of the example system 20 schematically shown in FIG. 1 is that at least one buffer member 40 is supported on at least one of the counterweights 24 or 34 to absorb impact associated with the counterweights contacting each other.

FIG. 2 schematically shows one example embodiment of a counterweight 24 having a buffer member 40 that is supported by the counterweight for movement with the counterweight within the hoistway 26. In this example, the counterweight 24 has a structure 42 that defines an outer boundary of the counterweight. In this example, the structure 42 comprises a frame that is made in a generally known manner. The outer boundary defined by the structure 42 includes a height dimension H and a width dimension W.

The illustrated example includes guide supports 44 that are outside of the outer boundary in this example. Of course, the guide supports 44 may be within the outer boundary, depending on the configuration of the counterweight structure. The guide supports operate in a known manner to facilitate moving the counterweight along the guide rails 36.

In the example of FIG. 2, the buffer member 40 has a first portion 52 that is within the outer boundary of the counterweight structure 42. A second portion 54 is beyond the outer boundary. In this example, a distal end 56 of the buffer member 40 is adapted to contact the other counterweight (i.e., the counterweight 34) before the counterweight structures would contact each other. In this example, the buffer member 40 has cooperating cylinders that operate in a known manner (i.e., hydraulic) to provide an energy absorbing function in the event that the counterweights move close enough to contact each other.

In the example of FIG. 2, the frame 42 supports a plurality of fillers 60. In one example, the fillers comprise plates as known. The fillers 60 have a lateral dimension that corresponds to the width W of the structure 42. The term “lateral” as used in this description refers to a direction taken in the width W direction as shown in the drawings. Of course, the size of the frame members and the size of the fillers 60 fit within the outer boundary of the counterweight 24.

The example of FIG. 2 also includes a plurality of second filler members 62 that have a second, smaller lateral dimension. In this example, two sets of second filler members 62 are provided, one on either lateral side of the first portion 52 of the buffer member 40. Accordingly, the filler members 62 have a dimension that corresponds to a difference between the width of the structure 42 and a width of the first portion 52 of the buffer member 40.

FIG. 3 shows another example including two buffer members 40. One difference between the examples of FIG. 2 and FIG. 3 is that the latter includes one set of second fillers 62 positioned between the buffer members 40.

In either of the examples of FIG. 2 and FIG. 3, the smaller, second fillers 62 provide for establishing a desired counterweight mass without increasing the height of the counterweight. In other words, the space within the outer boundary occupied by the first portion 52 of the buffer member 40 in the height direction may also be occupied by smaller fillers.

Although plate-style fillers are illustrated, other fillers are possible such as concrete and other known items.

Although the buffer member 40 is shown on the counterweight 24 in the illustrated example, it could also be provided on the counterweight 34 so long as the buffer faces the first counterweight 24 in the hoistway 26. Additionally, both counterweights may include at least one buffer member. The arrangements and placement of the buffer member or members will depend, in part, on a selected roping arrangement. Those skilled in the art who have the benefit of this description will be able to select an appropriate arrangement to meet their particular needs.

The preceding description is exemplary rather than limiting in nature. Variations and modifications to the disclosed examples may become apparent to those skilled in the art that do not necessarily depart from the essence of this invention. The scope of legal protection given to this invention can only be determined by studying the following claims.

We claim:

1. A counterweight for use in an elevator system, comprising:
a structure that defines an outer boundary of the counterweight; and
a buffer member that is supported for movement with the structure such that a first portion of the buffer member is within the outer boundary.

2. The counterweight of claim 1, wherein the buffer member has a second portion beyond the outer boundary.

3. The counterweight of claim 2, wherein the second portion is moveable relative to the first portion such that a distance between the outer boundary and a distal end of the second portion is variable.

4. The counterweight of claim 1, wherein the first portion remains in a fixed position relative to the structure.

5. The counterweight of claim 1, wherein the structure comprises a frame and including a plurality of fillers supported by the frame.

6. The counterweight of claim 5, wherein at least a first one of the fillers has a first dimension corresponding to a width dimension of the frame and at least a second one of the fillers has a second, smaller dimension corresponding to a difference between the width dimension of the frame and a width dimension of the first portion of the buffer member.

7. The counterweight of claim 6, wherein the second filler is positioned laterally on a side of the first portion.

8. The counterweight of claim 7, including second fillers on opposite sides of the first portion, respectively.

9. The counterweight of claim 6, including a plurality of the buffer members and wherein the second filler is positioned between the first portions of the buffer members.

10. The counterweight of claim 6, including a plurality of the first fillers and a plurality of the second fillers.

11. The counterweight of claim 5, wherein the fillers comprise plates.

12. An elevator system comprising:
a first elevator car in a hoistway;
a first counterweight in the hoistway that has a structure that defines an outer boundary of the first counterweight;
a first load bearing member coupling the first elevator car to the first counterweight;
a second elevator car in the hoistway below the first elevator car;
a second counterweight in the hoistway above the first counterweight, the second counterweight having a structure that defines an outer boundary of the second counterweight;
a second load bearing member coupling the second elevator car to the second counterweight; and
at least one buffer member associated with one of the first or second counterweights including a first portion supported within the outer boundary of the associated counterweight.

13. The system of claim 12, wherein the buffer member has a second portion beyond the outer boundary of the corresponding counterweight in a direction toward the other counterweight such that the second portion contacts the other counterweight before the counterweights contact each other.

14. The system of claim 13, wherein the second portion prevents the other counterweight from contacting the structure of the associated counterweight.

15. The system of claim 12, wherein the associated counterweight structure comprises a frame and including a plurality of fillers supported by the frame.

16. The system of claim 15, wherein at least a first one of the fillers has a first dimension corresponding to a width dimension of the frame and at least a second one of the fillers has a second, smaller dimension corresponding to a difference between the width dimension of the frame and a width dimension of the first portion of the buffer member.

17. The system of claim 16, wherein the second filler is positioned laterally on a side of the first portion.

18. The system of claim 17, including second fillers on opposite sides of the first portion, respectively.

19. The system of claim 16, including a plurality of the buffer members and wherein the second filler is positioned between the first portions of the buffer members.

20. The system of claim 16, including a plurality of the first fillers and a plurality of the second fillers.
